(19) United States
(12) Patent Application Publication
(10) Pub. No.: US 2005/0073430 A1
(43) Pub. Date: Apr. 7, 2005

(54) Vehicle signaling device

(76) Inventors: Leonardus Kusters, Amstelhoek (NL); Jeroen Ploeg, Leiden (NL); Aart Benschop, Pijnacker (NL); Dirk Verburg, Delft (NL); Albertus van der Knaap, Krimpen aan den Ijssel (NL)

Correspondence Address: Norris McLaughlin & Marcus, 220 East 42nd Street, 30th Floor, New York, NY, 10017, US

(21) Appl. No.: 10/399,000

(22) PCT Filed: Oct. 10, 2001
(86) PCT No.: PCT/NL01/00745

(30) Foreign Application Priority Data
Oct. 10, 2000 (NL) 1016371

(51) Int. Cl. G08G 1/00

(52) U.S. Cl. 340/901

(57) ABSTRACT

A signalling aapparatus for a motor vehicle is provided with communication means for receiving information coming from another motor vehicle and for broadcasting information intended for a nearby motor vehicle, and with sensor means for providing inforation about the status or status change of thr respective motor vehicle with regard to at least the safety of this vehicle. A computer is present for determining, on the ground of the information coming from the sensor means and/or on the ground of the received information, information to be broadcast and further action signals. In addition, means are present to enable, on the ground of the action signals, realization of a status change of the respective motor vehicle, which means are formed by a signalling element for making observable a signalling knowable for the driver of the vehicle or of a nearby vehicle.

The present invention relates to a signalling apparatus for a motor vehicle, provided with communication means for receiving information coming from another motor vehicle and for broadcasting information with regard to at least the safety of the first-mentioned motor vehicle to a further nearby vehicle.

A well-known phenomenon on highways where traffic density is high and vehicles are driving close to each other, is that at a system level a wave motion is involved. The ‘nodes’ here represent a locally high traffic density and the ‘troughs’ represent a relatively empty road section. The individual motorist experiences this phenomenon as disturbances in the form of sudden speed reductions of vehicles in front of him. When a driver is not sufficiently alert and does not react sufficiently fast, this leads to dangerous situations with an accident as a possible result.

Partly prompted by society's wish to that effect, much attention is paid to safety in the design of vehicles. This especially concerns passive safety, that is, safety aimed at minimizing the consequences of an accident. Improving passive safety is inherently realized at the level of a single vehicle. A well-known example is the crushable zone. Efforts in the field of active safety, that is, safety aimed at preventing accidents, take place at different levels. First, at a global level, that is, with regard to a whole road section. This has resulted in particular in infrastructure adaptations. Thus, at present, via electronic motorway signals, a lane can be closed off in case obstacles are located there. A second level at which active safety is realized is the vehicle level; safety is then focused on an autonomous vehicle. Thus, for instance, in the '90s, the third brake light was introduced. This makes it possible for drivers to observe a braking action not only of the vehicle immediately downstream, but also of vehicles further downstream. Thus, drivers can anticipate dangerous situations as mentioned above. An important disadvantage of the third brake light is that very often it is not possible to observe the brake light of several vehicles. The view is obstructed, for instance, by truck traffic or other large vehicles. Moreover, weather conditions may lead to strongly reduced visibility. However, experience shows that, also in situations where these physical impediments do not occur, the number of observable brake lights is always small. In addition, the information content is not high: the brake light only indicates that the vehicle is being braked, but not to what extent. As a consequence, by way of the third brake light of other vehicles, a driver only gets a very limited picture of the traffic situation in this system. This makes it difficult to realize a cooperative driving behavior, which is necessary to realize active safety.

In the above, it has been assumed that the driver is alert. However, under normal circumstances too, there are always shorter or longer periods of inattention, for instance due to distraction or fatigue. A development addressing this problem has yielded so-called advanced driver assistance (ADA) systems. This includes inter alia autonomous cruise control (ACC); this is a system which, in addition to the normal ‘cruise control’ function, is also capable of automatically maintaining a desired distance to the vehicle in front. ADA systems are focused primarily on increasing comfort. The vehicle autonomously tries to form a picture of its immediate environment This information is obtained with the aid of on-board sensors, while additional information can be obtained via infrastructure-bound communication systems (radio, GSM, and the like). From this abundance of signals, a status, that is, the condition of the vehicle, must be obtained, which leads to a possible intervention in the control of the vehicle, such as braking, steering, and the like. The intervention performed is only in the interest of the ADA vehicle. It is therefore highly questionable if ADA systems can enhance the safety of a group of vehicles on the road.

For the above reason, it has been sought to make active safety possible at a third level, between the global level and the vehicle level, that is, at a safety level pertaining to a group of vehicles, that is, a vehicle system, with an associated driving behavior. Thus, a signalling apparatus as described in the opening paragraph hereof, operative at this third safety level, is known from the French patent specification FRA-2,624,454. This known apparatus is intended, on the ground of received information broadcast by a vehicle in front, to adjust the lighting intensity of the lights of the respective vehicle, in other words, to realize one specific status change of the respective vehicle, and further to transmit adapted information to a following vehicle. The respective information is therefore very limited here, while automatically one specific status change of the respective vehicle is realized. In addition, a warning signal is transmitted from one vehicle to the next.

The object of the invention is to expand such a known system and, with the aid of supplementary measures, to farther enhance active safety, allowing status changes to be realized on a larger scale.

According to the invention, to that end, the signalling apparatus is characterized in that sensor means are present for providing information about the status or a status change of the respective motor vehicle with regard to at least the safety of this vehicle, as well as a computer which is arranged for generating action signals and information to be broadcast, on the ground of a combination of the information provided by the sensor means and information received from a nearby vehicle, and means to enable, on the ground of these action signals, initiation of a status change of the respective vehicle or of a vehicle present in the immediate vicinity, which means comprise a signalling element for making observable a signalling knowable for the driver of the respective vehicle or the vehicle present in the immediate vicinity. The information about the status or a status change comprises, for instance, deceleration information, speed information and/or position information. The means further comprise, for instance, actuators for the execution of autonomous actions by the respective vehicle on the basis of available information.

When a vehicle is the first vehicle in a group of vehicles driving in mutual proximity, then, in the computer, with the aid of the information about the status or a status change of the respective motor vehicle with regard to at least the safety of this vehicle, the above-mentioned action signals and the abovementioned information to be broadcast are determined. However, the computer will also be arranged to determine the action signals and information to be broadcast partly on the ground of information received from a nearby vehicle, typically a downstream vehicle.

A further nearby vehicle can be both an upstream vehicle (a vehicle following immediately or after a number of intervening vehicles), and a vehicle driving past laterally. In a simpler embodiment, the communication means are arranged on the front and rear side of the vehicle, allowing communication only with a following vehicle. In a more advanced embodiment, it is also possible to communicate with fixed infrastructure. Naturally, it remains possible to provide communication means on opposite sides of the respective vehicle, thereby enabling communication with a vehicle driving on the side, which may be of importance when a vehicle is joining traffic or is overtaking.

With the aid of such a signalling apparatus, it is rendered possible to gather time-critical information about the actions of other road users and to combine this information with the vehicle's own status. As a result, for several road users, an instantaneous and reliable picture of the traffic situation is obtained and a cooperative driving behavior is enabled. The signalling apparatus is able, on the basis of the combined information, and through the signalling element, to offer a driving advice to a respective driver, so that the latter obtains instantaneous and reliable support in driving or otherwise manipulating the vehicle. The information can also be used for initiating automatic actions by the vehicle with no or only limited driver intervention.

In an embodiment of the signalling apparatus according to the invention, the computer is arranged to generate combined information for the information to be broadcast, by
weakened transfer of an extent of exceptionality of the information received from the nearby vehicle and/or
enhancement of the extent of exceptionality of the combined information depending on the information provided by the sensor means.

The idea behind this is that in addition to the internal status of a particular vehicle, also the status of downstream vehicles plays a role in generating the information to be broadcast to an upstream vehicle. The idea is further that the upstream vehicles need to be influenced to a lesser extent by information from downstream vehicles according as the downstream vehicles are further ahead.

The extent of exceptionality is, for instance, a warning signal which can take different values of warning intensity or, more particularly, status information about braking actions which can take different values of increasing warning intensity. The combined signal is, for instance, determined by broadcasting information about a force of a braking action of a particular vehicle to a following vehicle, unless it appears from information of a vehicle in front that a weakened version of the force of braking action of this vehicle in front (or several such vehicles) is greater than the force of the braking action of the particular vehicle, in which case this weakened version is broadcast. Alternatively, combining can also lead to the joint broadcast by the vehicle involved of the information from the sensor means of the vehicle involved and received information from other vehicles, preferably with an indication of which information comes from the sensor means in the vehicle involved and which information comes from the other vehicles. Thus, a further receiving signalling apparatus receiving this combined information can itself combine this combined information.

The signalling apparatus has the following general advantages:
Drivers can anticipate possibly dangerous situations because they obtain information about a traffic situation along a particular proximal road section. In other words, the safety of the whole vehicle system is enhanced.
Much time is gained because drivers are no longer dependent on the propagation of conventional brake lights in a stream of vehicles. In the communication chain, the reaction time of other drivers required, for instance, to depress the brake pedal, is therefore no longer critical.
The information exchange is not dependent on the field of vision of the driver.
In principle, much more information can be exchanged than just information about whether or not downstream vehicles are braking or not. As a result, drivers can better react to the incident circumstances.

To determine with which vehicles communication is to take place, it is important to know each other's relative positions. This can be realized when the information to be passes comprises position and direction data, whereafter in a respective vehicle, on the basis of position and direction data coming from other vehicles, it is calculated which vehicles are relevant for the safety of the respective vehicle The disadvantage of this is that each vehicle must be equipped with a device to determine it own position and direction, for instance a global positioning system (GPS). Moreover, it requires much arithmetic capacity to determine from all received information which vehicle is eligible for communication from a safety point of view.

To circumvent this disadvantage, the communication means can he formed by an infrared communication system, more particularly, by an infrared transmitter and an infrared receiver on or in the vehicle. As an infrared transmitter involves a so-called transmission cone, the broadcast signal has a main direction which coincides with the axis of the cone. In case of a tailback, therefore, this allows well directed broadcast in rearward direction. When a next upstream car is equipped with an infrared receiver, that car will only receive signals coming from the front. This is referred to as line-of-sight communication: only connections between two immediately consecutive vehicles are effected. Thus the relative position of the two communicating vehicles is known. The infrared signal cannot penetrate through a car. The infrared system at the same time ensures that the information exchange is also maintained in the event of fog and heavy rain or snow.

In a preferred embodiment, the communication means are formed by connecting means which enable a line-of-sight connection between two vehicles driving behind each other, in combination with radio connecting means, wherein, when according to the line-of-sight, a connection between two vehicles driving behind each other has been effected, a data transmission by the vehicle in front to the following vehicle is realized with the aid of the radio connection. After the vehicle driving in front has broadcast a connecting signal, the following vehicle can broadcast an address signal, whereafter, with the aid of the radio connection, data can be transmitted to the vehicle defined by the address.

The advantage of a line-of-sight communication system is that it enables communication with a single vehicle relevant for the road user, without complicated analysis of the received information. Naturally, it remains possible to communicate with several vehicles, for instance both with a following vehicle and with a vehicle driving past on the side. Because in bends the infrared connection may be briefly broken, however, combination with a radio connection provides a solution for that as well. This implementation of inter-vehicle communication therefore combines the advantage of line-of-sight communication with that of a radio connection.

The status of a vehicle is determined by a large number of parameters, or signals. The transmission of all this raw information to other vehicles is consequently susceptible to error and requires powerful transmitter and receiver equipment. Also, a large arithmetic capacity of the board computers is required for analysis of the data. It is therefore favorable, instead of transmitting the raw information, to process this information already in the respective vehicle and to compress is to one safety status signal, which indicates the condition of the vehicle with regard to safety aspects. As a consequence, in principle, no conversion step is necessary to present this safety status signal in a manner comprehensible to the driver of the receiving vehicle. A simple possibility here is, for instance, a number on a scale from 0 to 5, with 5 indicating a serious situation which requires extreme attention on the part of the drivers in the receiving vehicles. As the information transfer is now less susceptible to error, less and hence cheaper equipment will suffice. Moreover, such a safety status signal can be made visible to the driver in a simple manner in the respective vehicle with the aid of a human machine interface and/or be used for generating an automatic reaction by the vehicle. The received safety status signal can be linked to the information from the sensor means of the vehicle. Through such linking, unnecessary control of the human machine interface can be prevented. The fact is, when the driver has already initiated the correct intervention, he no longer needs to be alerted. These sensor means can comprise means that indicate the position of the brake pedal. The sensor means can also comprise means determining the speed and/or acceleration of the vehicle.

An efficient and effective communication of the vehicle status received by a vehicle can be achieved through a brief, automatic depression of the brake pedal, based on the received information, while the extent of depression is related to the seriousness of the situation such as it appears from the received information. The reaction time of a driver is determined by the time required to process the received information and to actually initiate braking. This time is determined by the voluntary motor movements of the driver. The reaction time of the driver can now be effectively utilized in that during this time the means to enable a status change of the vehicle provide for an automatic braking. Moreover, the mechanical response time, due to a lost motion when a braking action is being performed, can be eliminated through this intervention.

An efficient and effective communication of the vehicle status received by a vehicle can further be achieved by means of a display, for instance in the form of a warning triangle, this triangle becoming larger or smaller in accordance with the seriousness of the situation. In particular the triangular form is completely in line with the conventional method (through road signs) of alerting road users to danger. It shortens the time the driver requires for interpretation, and he can react faster to critical situations in which surrounding road users are involved. Moreover, the interpretation requires little attention, which is beneficial to a safe conduct of the driver himself. The display can be built into a respective vehicle, naturally within the field of vision of the driver, or be arranged at the back of a vehicle and hence within the field of vision of the following vehicle. Instead of a display, brake lights can be used. If, for instance, the first vehicle in a row of three vehicles brakes, the brake lights of the second vehicle will go on, also if this second vehicle does not brake (yet). The third vehicle can then react to this, for instance by applying the brakes in anticipation. The advantage of this solution is that no displays need to be fitted on or in the vehicles. Moreover, the brake lights are always in the immediate field of vision of the driver. A disadvantage, however, is that the information provided by the brake lights is limited: on or off.

The signalling apparatus described here can obtain an advanced functionality, such that complex sensors, such as radar equipment, are required, with which the position and optionally the speed of the vehicle relative to other, neighboring vehicles is measured. In the vehicle status which is made knowable for the driver, the distance to a vehicle in front could then be taken into account as well: if the vehicle is very far away, the display is never fully controlled, even if this downstream vehicle makes an emergency stop. For this purpose, it is necessary to measure this distance, which, as mentioned, requires complex sensors. This raises the price and reduces the reliability of the system. If the functionality relates not only to the situation where vehicles are driving behind each other, but also to the situation where they are driving next to each other, it is even necessary to arrange these complex sensors all around the vehicles. Starting from the assumption that the vehicles are provided with means to communicate with each other, the above problem can be solved by providing each vehicle with a global positioning system based on, for instance GPS, GPRS (General Packet Radio Service) or UMTS (universal Mobile Telecommunications System), which functions as sensor for measuring at least the position of the respective vehicle. If presently, by way of the inter-vehicle communication, at least information about each other's position is transferred, it is possible in a simple manner to calculate the relative distance for the purpose of, for instance, a more accurate determination of the vehicle status and/or the status to be represented on the display. Because such systems can typically determine the speed of the vehicle as well, it is possible, when the speed is also transferred, to calculate the relative differential speed and use it for the purpose of status determination and status representation. Global positioning systems are more and more often included in road vehicles, typically to generate information for the purpose of an on-board navigation system. For this reason, these positioning systems are relatively inexpensive and reliable. Complex sensors for generating position and speed information are then redundant. It should be noted that the positioning system is not used here to determine which road vehicles are relevant to each other from the viewpoint of safety. For this is the task of the line-of-sight communication system.

The invention will now be further elucidated with reference to the accompanying drawing. In the drawing:

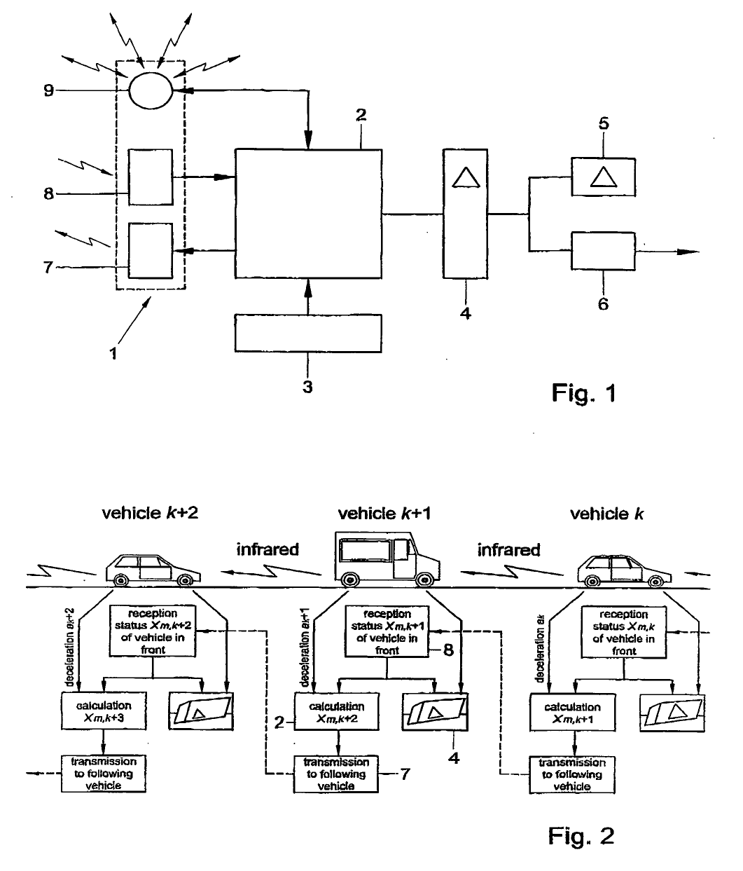

FIG. 1 shows a block diagram of a first embodiment of the signalling apparatus according to the invention; and

FIG. 2 shows a schematic representation of a second embodiment of the signalling apparatus according to the invention, shown for a group of vehicles.

In the figures, corresponding parts are indicated by the same reference numerals.

The signalling apparatus represented in FIG. 1, which relates to an embodiment in which the vehicles are assumed to drive wholly behind each other, comprises communication means 1, a computer 2, sensor means 3, means 4 to enable realization of a status change of the vehicle, a display 5 and an automatic brake operation 6. The communication means 1 are formed by an infrared transmitter 7 which can be fitted on or in the back of a vehicle, an infrared receiver 8 which can be fitted on or in the front of the vehicle, and a radio transmitter and receiver installation 9.

When a following vehicle has approached the vehicle in front to a sufficient extent, the following vehicle receives an infrared signal broadcast by the vehicle in front. With the aid of the infrared transmitter 7, an address is passed to the vehicle in front, which, with the aid of the radio transmitter and receiver installation 9, thereupon broadcasts a safety status signal intended exclusively for the following vehicle. It is also possible that the vehicle in front passes on a connecting signal with address to the following vehicle, which in turn transmits a confirmation signal to the vehicle in front. The latter, with the aid of the radio transmitter and receiver installation 9, can then broadcast a safety status signal intended exclusively for the following vehicle again. However, other solutions with regard to the communication also remain possible.

By way of the radio transceiver 9 of the following vehicle, the safety status signal is received, detected and processed and then fed to the computer 2. Together with the information of the sensor means 3 in the following vehicle, a new safety status signal is determined, which can be broadcast again. Also, on the basis of the received safety status signal in combination with the information of the sensor means 3, in this case a speedometer and an accelerometer, action signals can be determined which are fed to the means 4. These means enable a change in the condition of the vehicle and to that end comprise, for instance, a display arranged in the vehicle, on which a warning triangle varying in size can be displayed, so that the driver can see immediately when an action, such as braking or corrective steering, is to be taken. According as the triangle increases in size, the danger is greater and action by the driver more urgent. On the basis of the action signals mentioned, with the aid of the means 4, at the same time a signal can be generated for the unit 6 to enable an automatic braking operation (and/or accelerator pedal operation) to be performed. In order that, apart from the transfer of a safety status signal, the driver of a following vehicle—when, for instance, it is not provided with a signalling apparatus as described here—be warned anyhow, a display 5 may be provided on the back of the vehicle. On this display, too, a warning triangle varying in size may be represented. However, this information is not necessarily identical to that on the display in the vehicle.

In the embodiment of FIG. 2, the communication means are limited to an infrared transmitter and infrared receiver 7 and 8, respectively. The information transmitted consists of a safety status signal which indicates the extent of deceleration of the vehicle or of vehicles in front of it. For this purpose, use is made of the information from the sensor means 3 in the vehicle, which sensor means in this example measure the position of the brake pedal and/or the acceleration in forward direction. This status signal is calculated as follows:

Let is be assumed that aₖ is the deceleration in [m/s²] of vehicle k. aₖ therefore indicates that the vehicle is being braked. This braking action is compressed by providing a limited number of levels therein. If this compression is represented by the function f, then f(aₖ) is a number giving an indication of the extent of braking. Starting from the “resolution” of a driver, f(aₖ) is chosen to have six values: 0-5. The determination of the status x_{m,k} of vehicle k is now done with the aid of the braking action f(aₖ) and the status of the vehicle in front x_{m,k-1}. For this purpose, the following recursive function is used: x_{m,k}=max {f(aₖ), x_{m,k-1}-q} wherein x_{m,k-1} is the status of the vehicle in front k−1. The constant q is a “weakening term”. The status x_{m,k-1}, just like f(aₖ), has a value varying from 0 to 5. By reducing this value by q, a weakening is obtained; if it is chosen that q=1, then, after five vehicles, the status will have become equal to 0. The idea behind this is that upstream vehicles are less dependent on, or are less influenced by, the front vehicle according as they are further away from the front vehicle. In addition to the status of a vehicle in front, also the internal condition plays a role. This is taken into account by taking the maximum of the incoming weakened status (x_{m,k-1}-q) and the vehicle's own braking action f(aₖ). The status x_{m,k-1} is presented to the driver of vehicle k, viz. on a display on which a warning triangle varying in size is displayed. He reacts to it, which yields a value for f(aₖ). With the aid of the above relation, next, the status x_{m,k} is calculated, which, finally, is forwarded to the following vehicle k+1. Also when the driver does not react, this algorithm results in a useful status to be transmitted.

The invention is not limited to the exemplary embodiments described here with reference to the figures, but comprises all kinds of modifications thereon, naturally insofar as they fall within the scope of protection of the following claims.

1. A signalling apparatus for a motor vehicle, provided with communication means for receiving information coming from another motor vehicle and for broadcasting information with regard to at least the safety of the first-mentioned motor vehicle to a further nearby vehicle, characterized in that
sensor means are present for providing information about the status or a status change of the respective motor vehicle with regard to at least the safety of this vehicle, as well as
a computer which is arranged for generating action signals and information to be broadcast, on the ground of a combination of the information provided by the sensor means and information received from a nearby vehicle, and -means to enable, on the ground of these action signals, initiation of a status change of the respective vehicle or of a nearby vehicle, which means comprise a signalling element for making observable a signalling knowable for the driver of the respective vehicle or the nearby vehicle.

2. A signalling apparatus according to claim 1, characterized in that the computer is arranged to generate combined information for the information to be broadcast by
weakened transfer of an extent of exceptionality of the information received from the nearby vehicle and/or
enhancement of the extent of exceptionality of the combined information depending on the information provided by the sensor means.

3. A signalling apparatus according to claim 1, characterized in that the communication means are arranged on the front side and rear side of the vehicle.

4. A signalling apparatus according to claim 1, characterized in that the communication means comprise at least one infrared transmitter and infrared receiver.

5. A signalling apparatus according to claim 1, characterized in that the communication means are formed by connecting means which enable a line-of-sight connection between two vehicles driving within view of each other, as well as radio connecting means, wherein, when according to the line-of-sight a connection between two vehicles driving within view of each other has been established, a data transmission by the broadcasting vehicle to the receiving vehicle is realized with the aid of the radio connection.

6. A signalling apparatus according to claim 1, characterized in that the information to be broadcast is formed by a single safety status signal.

7. A signalling apparatus according to claim 6, characterized in that in the vehicle a display is present for displaying, on the ground of a received safety status signal, a warning signal for the driver of this vehicle.

8. A signalling apparatus according to claim 6, characterized in that at the back of the vehicle, a display is present for displaying, on the ground of a received signal and on the ground of signals produced by the sensor means, a warning signal for the driver of a following vehicle.

9. A signalling apparatus according to claim 6, characterized in that the vehicle is provided with brake lights for displaying, on the ground of a received safety status signal, a warning signal for the driver of a following vehicle.

10. A signalling apparatus according to claim 7, characterized in that the warning signal is in the form of a warning triangle which lights up to an increasing extent as to its dimensions according as the safety status signal represents a greater danger.

11. A signalling apparatus according to claim 6, characterized in that the means for enabling a status change of the vehicle or of a nearby vehicle are formed by brake energization means controlled by the safety status signal.

12. A signalling apparatus according to claim 1, characterized in that the sensor means comprise means indicating the position of the brake pedal.

13. A signalling apparatus according to claim 1, characterized in that the sensor means comprise means determining the speed and/or the acceleration of the vehicle.

14. A signalling apparatus according to claim 1, characterized in that the sensor means comprise a global positioning system, which functions as sensor for measuring at least the position of the respective vehicle.
